(19) United States
(12) Patent Application Publication
(10) Pub. No.: US 2003/0214535 A1
(43) Pub. Date: Nov. 20, 2003

(54) User interface for a messaging device and method

(75) Inventor: James Hymel, Lake Worth, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/144,916

(22) Filed: May 14, 2002

(51) Int. Cl. G09G 5/00

(52) U.S. Cl. 345/814; 345/827

(57) ABSTRACT

A user interface and method of providing the interface for a messaging device 200 includes detecting activation 303 of an alphanumeric key 213 from a set of keys 211 comparing a status of the messaging device to a predetermined status 305; and when the comparison is unfavorable presenting a normal interface procedure 307 for the messaging device; and when the comparison is favorable 309 presenting a quick interface procedure for the messaging device.

### FIELD OF THE INVENTION

This invention relates in general to communication systems, and more specifically to a messaging system and a user interface and method thereof for a messaging device operating therein.

### BACKGROUND OF THE INVENTION

Messaging systems or systems suitable for providing messaging service are known. Messaging devices or devices having messaging capability as one of many capabilities that are arranged and constructed for operating therein are also known. However the wide range of user features and messaging device operating modes and options and add on applications has led to user interfaces or graphical user interfaces that can be unwieldy or at least lengthy and thus inefficient for various typical modes of operation for such devices.

For example, typically the interface procedure for many devices includes obtaining a first menu, selecting from the first menu which selection makes available another menu, from which a selection is made and so on hierarchically until the user arrives at the desired activity. For many more or less routine activities such as sending messages or replying to messages this can become frustrating for the typical user. However, often the relatively complex and hierarchical menu structure is definitely required. Clearly a need exists for a more user friendly and flexible user interface.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a messaging system and messaging devices suitable for utilizing a user interface according to the present invention;

FIG. 2 depicts a block diagram of a preferred embodiment of a user interface within a messaging device according to the present invention;

FIG. 3 illustrates a flow chart of a preferred method embodiment of providing a user interface according to the present invention that is suitable for operating in the messaging device of FIG. 2; and;

FIG. 4 depicts a more detailed flow chart of a method embodiment of providing a user interface according to the present invention.

### DETAILED DESCRIPTION OF PREFERRED EMBODIMENTS

In overview form the present disclosure concerns communications systems that provide services and specifically messaging services to communications units or more specifically messaging units or devices and users thereof operating therein. More particularly various inventive concepts and principles embodied in user interfaces and methods thereof for providing such interfaces for the convenience and advantage of such users are discussed. The communications systems and messaging devices that are of particular interest are those that provide or facilitate messaging services, such as conventional two way messaging systems and devices, GPRS (General Packet Radio System) systems or those being planned that utilize SMS (Short Messaging Service) protocols or systems and devices that are packet data enabled and that enable connectivity or sessions with IP (Internet Protocol) based networks, such systems and devices including future packet data based systems such as 3^{rd} generation or UMTS (Universal Mobile Telephone Systems) systems.

As further discussed below various inventive principles and combinations thereof are advantageously employed to provide alternative operating procedures for a user interface to a messaging device depending on the status of the messaging device and user actions, thus alleviating various problems associated with known user interfaces while still facilitating a full range of features, options and applications for the messaging device provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

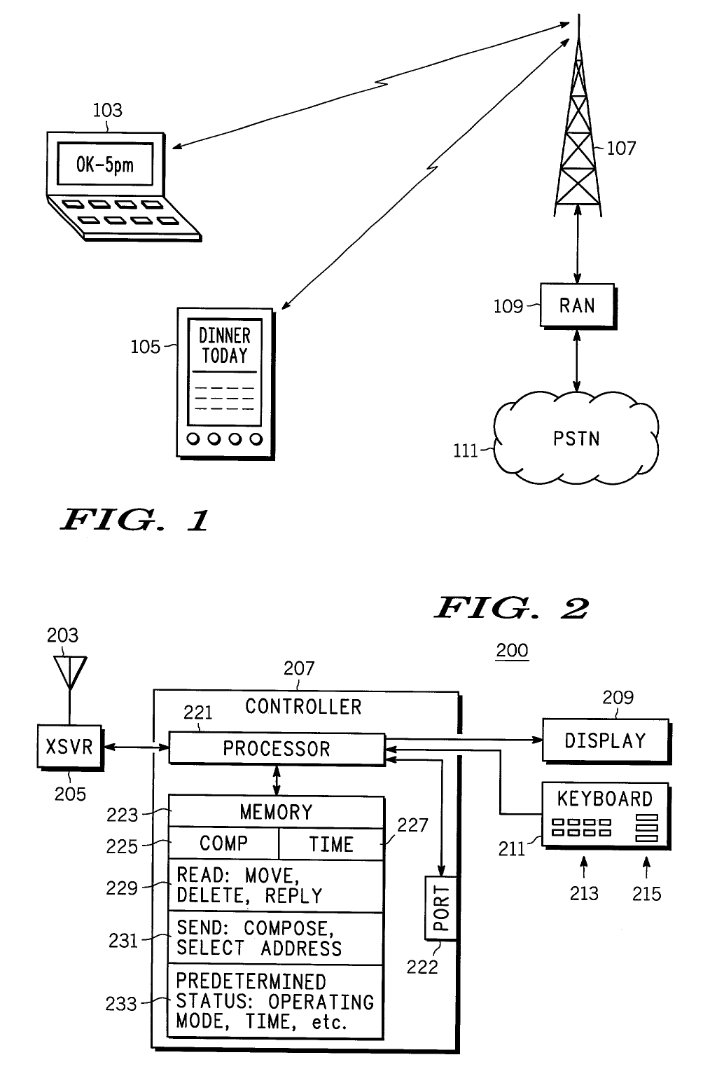

Referring to FIG. 1, a simplified and exemplary messaging system and messaging devices suitable for utilizing a user interface according to the present disclosure will be discussed and described. The messaging devices 103 and 105 are arranged and constructed to send and receive messages over the wireless links to and from the antenna structure 107 as well as manage messages that have been received, etc. The antenna structure is coupled to or may be considered to be part of a RAN (Radio Access Network) 109 that ordinarily operates to couple the PSTN (Public Switched Telephone Network) 111 or other networks such as packet data networks like the Internet, Web, etc. to the messaging devices.

The messaging device 103 demonstrates one common form of such a device where the device has a display and a separate keyboard or set of keys as depicted. Device 105 suggests another variety where the device has a relatively larger display area and a keyboard or set of keys that is a virtual keyboard that is depicted as part of the display. These messaging devices each ordinarily have a user interface that allows a user to interact with and operate the device in accordance with what will be termed herein an interface procedure. Often this is a hierarchically driven menu system meaning that the user first selects a menu, then an item from that menu which leads to another menu and so on until a desired action can be performed. This is at least partially the result of the large number of features or functions and applications that a given device may be expected to provide. For example in addition to receiving and sending or transmitting messages the device will likely be capable of managing messages in various folders, deleting messages, managing and maintaining an address book, selecting various user preferences and device operational parameters, as well as launch and utilize sundry other applications such as games, calculators, and so on. Thus a messaging device in response to a user activating a given alpha numeric key on the keyboard will likely have no idea what the user wishes to do and thus do nothing or may at best select or make available a menu related to that key. This is unfortunate because the user in order to accomplish the most basic tasks must find there way through the menu system. In certain operational situations this can be resolved or dramatically improved given the concepts and principles discussed herein.

Referring to FIG. 2 a block diagram of a preferred embodiment of a user interface within a messaging device 200 will be discussed and described. The messaging device 200 includes the antenna 203 that operates to radiate and absorb radio frequency signals that are transmitted or sent from or received by a transceiver 205 of the messaging device as is known. The transceiver 205 interactively operates with a controller 207 to provide to or accept or receive from the controller 207, messages or signals corresponding thereto as is also known. The controller 207 is coupled to and operates together with a display 209 and a keyboard 211 or set of keys including alphanumeric keys 213 and non-alpha numeric keys 215 to effect a user interface. The keyboard can be a known physical keyboard or virtual keyboard that is part of the display and the display is also known and may be a liquid crystal display or the like. If the keys are part of a virtual keyboard the display will need to be touch sensitive or the like in order to convey information to the controller 207.

The controller 207, preferably, includes a processor 221 that is, preferably, a known micro-processor based element that is widely available and may include one or more micro processors and one or more digital signal processors depending on the precise responsibilities of the controller with respect to signaling duties that are not here relevant. The processor 221 may be coupled to a port 222 that allows an external device, such as a portable computer or the like to interface to the messaging device and thus become, for example, a part of the user interface or a diagnostic and testing apparatus. In any event the processor 221 is also coupled to a memory 223 that may be a combination of known RAM, ROM, EEPROM or magnetic memory that among other items, such as messages and folders with messages, address books, standard or canned messages, and various operating variables and parameters will store operating software or code for the processor. This operating software when executed by the processor will result in the processor performing the requisite functions of the messaging device such as interfacing with the transceiver, display and keyboard and so on including others that will be further described below. As depicted the memory includes routines that represent a comparator 225, timers for assessing lapsed times 227, routines for driving operating modes such as Read, Move, and Delete a message and Reply to a message 229, routines for Sending a message 231 including composing the message and selecting an address as well as predetermined status parameters 233, such as operating modes, lapsed times, etc. The reader will appreciate that this listing is merely a brief listing of exemplary routines that will be required or advantageous in effecting a user interface and that optional applications that may be stored in the memory have not been mentioned.

Briefly in operation the user interface for the messaging device includes the set of keys or keyboard 211 including alphanumeric and non alphanumeric keys 213 and 215 where the non alpha numeric keys may include for example control keys such as a menu key, clear, enter, and so on keys and the display 209 for providing visual interaction for a user of the messaging device; and the controller 207 or processor 221. The controller is coupled to the set of keys and the display and operates to or for driving the display and detecting activation of an alphanumeric key from the set of keys; comparing, using the compare routine 225 a status of the messaging device, determined by where within the operating software routines the processor is executing instructions to a predetermined status 223. When the comparison is unfavorable and responsive to the activation the controller will present via the display and keys a first interface procedure that may be designated as a normal interface procedure for the messaging device. For example this would be obtaining a menu, select an item from the menu, and so on interface procedure. However, when the comparison is favorable and responsive to the activation of the alpha numeric key, the controller would present a second interface procedure for the messaging device using the keys and the display, where the second interface procedure differs from the first interface procedure and may be designated as a quick or abbreviated interface procedure whereby various steps of the hierarchical menu structure could be foregone.

For example, a common action desired by a user of a messaging device is sending a message. When the user accesses the messaging device and the alpha key activation is detected, the controller or processor can compare the status to a predetermined status or specifically doing so includes comparing a time lapse since a key from the set of keys was activated to a predetermined time lapse. For example if the time lapse since any key was activated has been over a minute and thus exceeds a predetermined time lapse of a minute it may be appropriate and efficient to assume that the user now wants to send a message. Thus the comparison is favorable and the second or quick interface procedure is presented, responsive to the alphanumeric key activation. This second interface procedure would, preferably, include immediately entering a message composure mode or routine. If the comparison was unfavorable e.g. the time lapse does not exceed the predetermined time lapse then the first or normal interface procedure would be presented and the unit would not enter the message composure routine.

The message composure routine, preferably, includes composing a message corresponding to alphanumeric keys that are activated and displaying the message as it is composed on the display and thereafter selecting an address and sending the message via a control key or the like. The message composure routine may first include selecting a standard or canned message, such as “call me” or selecting an address to which the message will be sent and in the latter case thereafter composing the message. The relative advantage to the user is the interface procedure has forgone one or more menu selection steps or processes. The appropriate predetermined time, here described as one minute can be heuristically determined taking into consideration how long the messaging device or user interface will remain active once all activity seems to have stopped and individual user tastes. The predetermined time can as well be a user programmable parameter. In any event it may be that the alphanumeric key was simply activated by mistake or mistakenly motivated and thus the message composure routine has been mistakenly entered. This is resolved by activating a non-alpha numeric key such as a menu access key and upon detection of the activation of a non alphanumeric key and responsive thereto simply forgoing the second interface procedure, clearing the display of any partially composed messages and the like, and presenting the first or normal interface procedure.

One further example is where the process of comparing the status to a predetermined status includes comparing an operating mode of the messaging device to a predetermined operating mode. For example suppose the operating mode is a read mode or message reading mode that incidentally is also a common activity for a user. A user when reading a message very often wishes to reply to that message although they may want to delete the message or move it to a folder for later access. Thus when the comparison is favorable, namely the controller or processor compares its present operating mode or read mode to the predetermined operating mode that is also read mode, the second or quick interface procedure is presented, responsive to the alphanumeric key activation, and this interface procedure includes immediately entering a reply operating mode wherein a reply to a message being read can be composed and naturally when the operating mode is not a message reading mode the reply operating mode is not entered. The reply operating mode preferably includes composing a reply message corresponding to alphanumeric keys that are activated and displaying the reply message as being composed on the display and then sending the reply message. The reply operating mode can also or alternatively includes selecting a standard reply message from a plurality of standard or canned reply messages, such as “on the way” etc. or the message composing mode. Again mistakes can be remedied by selecting a non-alphanumeric key such as a menu or esc key.

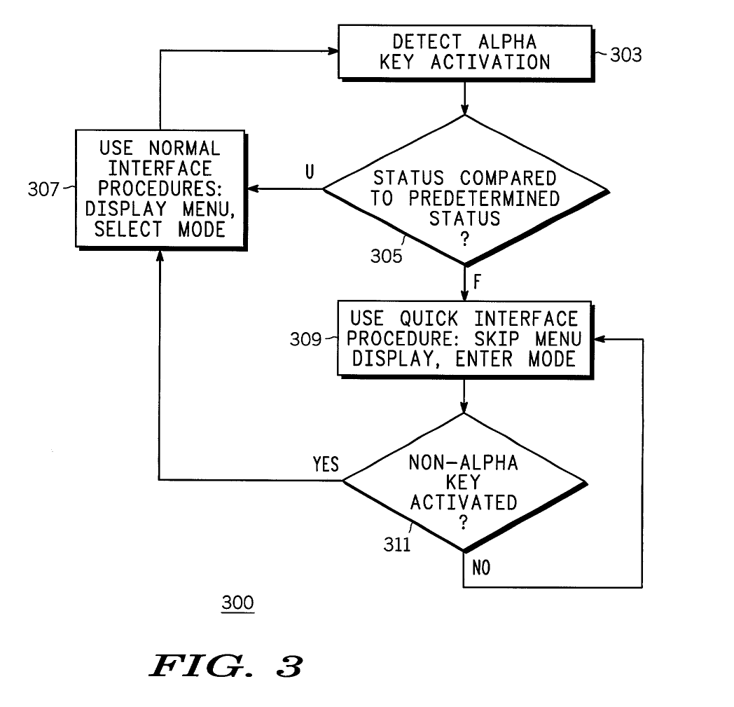

Referring to FIG. 3 a flow chart of a preferred method embodiment of providing a user interface that is suitable for operating the messaging device of FIG. 2 will be described and discussed. Note this will be somewhat of a review of the above noted principles and concepts. FIG. 3 illustrates a method 300 of providing an efficient user interface for a messaging device. The method begins at step 303 by detecting activation of an alphanumeric key from a set of keys. Step 305 compares a status of the messaging device, such as operating mode or time in a given mode or the like to a predetermined status. When the comparison is unfavorable step 307 depicts presenting and using a normal interface procedure, such as a hierarchical menu system, for the messaging device. If the comparison at 305 is favorable then step 309 shows a second or quick interface procedure for the messaging device being used or presented to the user. This quick interface procedure would skip one or more steps of the menu system, going directly to a likely desired mode of operation such as composing a message. As indicated by step 311 at any time a non-alpha numeric key such as a menu key was activated, the second or quick interface procedure would be discontinued and the interface procedure would revert to the normal procedures at step 307.

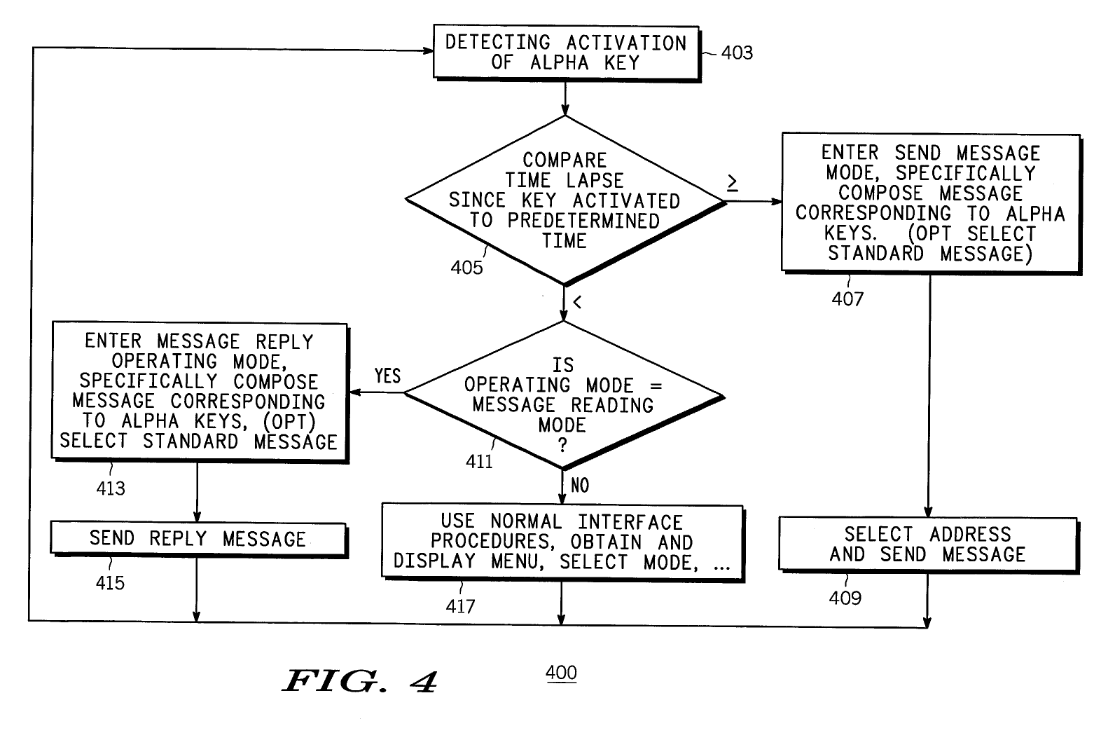

Referring to FIG. 4 a more detailed flow chart of a method embodiment of providing a user interface will be discussed and described. This discussion will be somewhat of a review of the two examples, discussed above, of opportunities to make the interface procedures more user friendly and efficient. The method 400 shows an approach of providing an efficient user interface for a messaging device in more detail than FIG. 3. The method begins at 403 with detecting activation of an alphanumeric key from a set of keys and then at step 405 compares a status, specifically time lapse since a key (alpha or non-alpha) from the set of keys was activated to a predetermined time. If the comparison is favorable meaning more time has lapsed than the predetermined time the interface procedure at step 407 is presented or a send message mode and specifically message composure mode or routine is entered wherein a message is composed that corresponds to alphanumeric keys that are activated. Optionally a standard message could be selected and then step 409 shows an address selection is undertaken and the message is sent or transmitted by the messaging unit. Though not depicted, at any point a non-alphanumeric key such as a menu or esc key is activated the user interface can revert to a standard interface or alternatively pull down a menu and allow the user to make a selection or continue activating alphanumeric keys thus suggesting that the non-alphanumeric key activation was an error.

If at step 405 the time lapse is less than a predetermined time, step 411 compares the status of the messaging unit to a predetermined status and more specifically tests or compares whether an operating mode of the messaging device is a predetermined operating mode or here a message reading mode. If so step 413 shows the user interface or controller entering a reply operating mode wherein a reply to a message being read can be composed, the reply message corresponding to alphanumeric keys that are activated. Optionally a standard reply message can be selected and then step 415 shows the reply message being sent or transmitted by the messaging unit. If at 411 the operating mode is not a message reading mode, step 417 depicts using a normal interface procedure of obtaining and displaying a menu, selecting from the menu and so on and thus the reply operating mode is not entered.

The processes and user interfaces discussed above and the inventive principles thereof are intended to and will alleviate problems caused by prior art user interfaces. Using these principles of skipping various menu steps will simplify certain common processes a user of a messaging device does routinely such as sending a message or replying to a message and thus facilitate user interface efficiency and friendliness and thus satisfaction. It is expected that one of ordinary skill given the above described principles, concepts and examples will be able to implement other alternative interface procedures that are messaging device status dependent and that will also offer additional quick and efficient interface procedures. It is anticipated that the claims below cover such other examples.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of providing an efficient user interface for a messaging device, the method including the steps of:
detecting activation of an alphanumeric key from a set of keys;
comparing a status of the messaging device to a predetermined status;
when said comparison is unfavorable and responsive to said activation, presenting a first interface procedure for the messaging device; and
when said comparison is favorable and responsive to said activation, presenting a second interface procedure for the messaging device, said second interface procedure differing from said first interface procedure.

2. The method of claim 1 wherein said step of comparing said status to a predetermined status further includes comparing a time lapse since a key from said set of keys was activated to a predetermined time lapse.

3. The method of claim 2 wherein when said time lapse exceeds said predetermined time lapse said second interface procedure is presented, responsive to said activation, and includes immediately entering a message composure routine and when said time lapse does not exceed said predetermined time lapse not entering said message composure routine.

4. The method of claim 3 wherein said message composure routine includes composing a message corresponding to alphanumeric keys that are activated.

5. The method of claim 3 wherein said message composure routine includes one of selecting a standard message and selecting an address.

6. The method of claim 3 further including detecting activation of a non alphanumeric key and responsive thereto forgoing said second interface procedure and presenting said first interface procedure.

7. The method of claim 3 wherein said comparing said status to a predetermined status further includes comparing an operating mode of the messaging device to a predetermined operating mode.

8. The method of claim 7 wherein said when said operating mode is a message reading mode said second interface procedure is presented, responsive to said activation, and includes immediately entering a reply operating mode wherein a reply to a message being read can be composed and when said operating mode is not a message reading mode not entering said reply operating mode.

9. The method of claim 1 wherein said reply operating mode includes composing a reply message corresponding to alphanumeric keys that are activated.

10. The method of claim 1 wherein said reply operating mode includes selecting a standard reply message.

11. A user interface for a messaging device comprising in combination:
a set of keys including alphanumeric and non alphanumeric keys;
a display for providing visual interaction for a user of the messaging device; and
a controller, coupled to said set of said keys and said display, for;
driving said display and detecting activation of an alphanumeric key from said set of keys;
comparing a status of the messaging device to a predetermined status;
presenting, when said comparison is unfavorable and responsive to said activation, a first interface procedure for the messaging device using said keys and said display; and
presenting, when said comparison is favorable and responsive to said activation, a second interface procedure for the messaging device using said keys and said display, said second interface procedure differing from said first interface procedure.

12. The user interface of claim 11 wherein said comparing said status to a predetermined status further includes comparing a time lapse since a key from said set of keys was activated to a predetermined time lapse.

13. The user interface of claim 12 wherein when said time lapse exceeds said predetermined time lapse said second interface procedure is presented, responsive to said activation, and includes immediately entering a message composure routine and when said time lapse does not exceed said predetermined time lapse not entering said message composure routine.

14. The user interface of claim 13 wherein said message composure routine includes composing a message corresponding to alphanumeric keys that are activated and displaying said message on said display.

15. The user interface of claim 13 wherein said message composure routine includes one of selecting a standard message and selecting an address.

16. The user interface of claim 13 further including detecting activation of a non alphanumeric key and responsive thereto forgoing said second interface procedure, clearing said display, and presenting said first interface procedure.

17. The user interface of claim 13 wherein said comparing said status to a predetermined status further includes comparing an operating mode of the messaging device to a predetermined operating mode.

18. The user interface of claim 17 wherein when said operating mode is a message reading mode said second interface procedure is presented, responsive to said activation, and includes immediately entering a reply operating mode wherein a reply to a message being read can be composed and when said operating mode is not a message reading mode not entering said reply operating mode.

19. The user interface of claim 11 wherein said reply operating mode includes composing a reply message corresponding to alphanumeric keys that are activated and displaying said reply message on said display.

20. The user interface of claim 11 wherein said reply operating mode includes selecting a standard reply message from a plurality of standard reply messages.
